(19) United States
(12) Patent Application Publication
(10) Pub. No.: US 2024/0250552 A1
(43) Pub. Date: Jul. 25, 2024

(54) A PORTABLE POWER UNIT

(71) Applicant: Green Energy AS, Oslo (NO)

(72) Inventor: Karl ANDREASSEN, Vejle (DK)

(73) Assignee: Green Energy AS, Oslo (NO)

(21) Appl. No.: 18/566,319

(22) PCT Filed: May 31, 2022
(86) PCT No.: PCT/EP2022/064750

§ 371 Date: Dec. 1, 2023

(30) Foreign Application Priority Data
Jun. 3, 2021 (NO) 20210701

(51) Int. Cl. H02J 7/02; B60R 16/033; H02J 3/32; H02J 3/38; H02J 7/00

(52) U.S. Cl. CPC H02J 7/02; B60R 16/033; H02J 3/32; H02J 7/00032; H02J 7/0013; H02J 7/0042; H02J 3/38; H02J 2207/20; H02J 2300/26

(57) ABSTRACT

A portable power unit (1) including a battery management system, BMS, (3) for high current charging of batteries, especially Lithium batteries. The system is connected to a power source of a suitable type and a battery pack (2) to be charged. The battery management system includes a charging circuitry including a set of parallel low resistant MOSFET transistors distributing the power to the battery pack.

### TECHNICAL FIELD

The present invention relates to a portable power unit according to the preamble of the subsequent claim 1.

### BACKGROUND ART

Portable power units have existed for a long time. Such units are useful for emergency power in situations when there is a power failure or in places where there is no electrical grid. These power units may be used to run any type of electrical appliance, but are particularly useful for powering electric power tools, such as saws, drills and other tools for building purposes.

Until a few years ago, such portable power units were generators having a combustion engine, a generator and a regulator, including an alternator. The engine is rotating the generator, which in turn produces an electric current. The current is supplied to the regulator, which turns the electric current into a desired electric output, such as 230V AC. The regulator may contain an inverter to create the desired phase and frequency of the electric output.

However, engine driven generators are both noisy and creates pollution. They cannot be used indoors over any length of time. Consequently, over time many emergency power systems and systems have been created to store electrical energy for a period of time and then convert the battery power to 110V or 230V AC so that this can be used for various appliances. These systems are typically called ES or EES systems, consisting of a charger, a battery and an inverter.

These types of power units have been used as portable units or for fixed mounting in buildings.

As an example of a need for electric power, a craftsman drives his van to a construction site. It turns out that the site has not yet been connected to the electric grid. However, the craftsman needs a reliable power supply of 110V or 230V AC to operate his machines.

Conventionally, the craftsman would bring a petrol or diesel generator which is set to run through the day when power is needed.

An alternative is to use large batteries built into the craftsman's car which are either charged from home or via the car's electrical system when the vehicle engine is running on the way to the construction site. From the batteries the power is taken via a conventional 12/24V-110/230V inverter. If the amount of power becomes too low, the car is started, and the engine is run to produce the power. However, a Euro6 engine cannot generate electricity when running at a lower speed than 2500 rpm, so the engine must run at a higher speed.

### SUMMARY OF INVENTION

The present invention is directed at mobile installations and the unit is designed to charge directly from the existing electrical system of a vehicle, ship or other mobile facility. It may also be charged from solar cells or from a connection to public or private electricity grids.

Recently, there are many construction sites that have imposed restrictions, such as requiring CO2-free operation. These environmental requirements are getting stricter by the day. Therefore, the petrol/diesel generator is no longer a viable solution.

For the craftsman's van, there have also been imposed greater requirements. The introduction of the Euro 6 emission requirements means that the car engine will work poorly to generate electricity, as the car's generator in principle does not work below an engine speed of 2500 rpm.

Consequently, using the van's engine for charging the batteries is already today limited. In a few years, the craftsman's van will probably be fully electric.

Hence, there is a need for a reasonably light power unit that can fit in a small van and can be carried by hand to close proximity of the place where electrical appliances are to be used, and which is pollution free and can supply sufficient energy to last through a normal working day.

### BRIEF DESCRIPTION OF DRAWINGS

FIG. 1 shows a schematic setup of the power unit and the surrounding infrastructure,

FIG. 2a shows an alternative configuration where the BMS is included in a control unit, and

FIG. 2b illustrates the power distribution circuitry in the control unit.

### DETAILED DESCRIPTION OF THE INVENTION

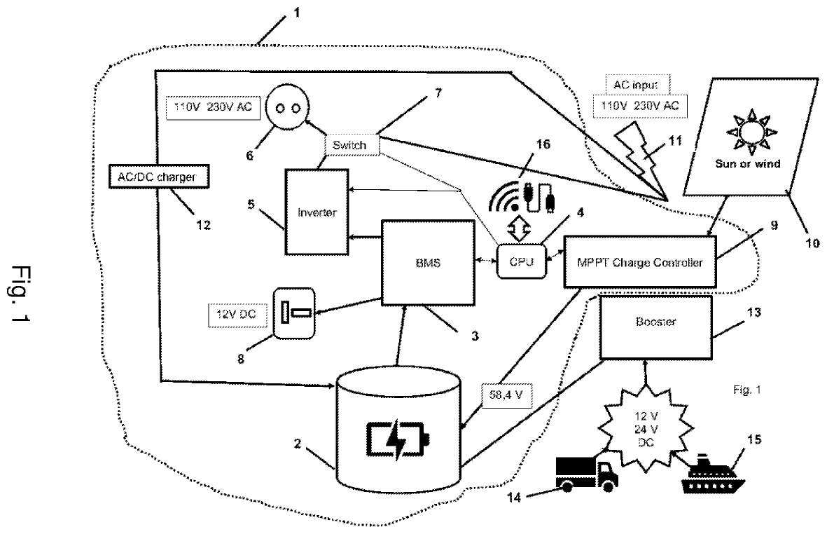

FIG. 1 shows a schematic setup of the power unit according to the invention as well as the surrounding infrastructure. The components inscribed by the dotted contour 1 are integrated into the power unit.

The power unit 1 contains a battery 2 for storage of electric energy. The battery is connected to a battery management system module (BMS) 3, which in turn is controlled by a processor (CPU) 4.

The BMS 3 is coupled to an inverter 5, which in turn is coupled to an electric outlet 6 through a switch 7. Through the BMS 3, inverter 5, switch 7 and outlet 6, the battery is capable of delivering mains electricity (generally 110 V or 230 V) to supply electric appliances such as power tools.

The CPU 4 is also set to control the inverter 5 and the switch 7.

The BMS 3 is also coupled to a 12 V outlet 8, to enable the battery to deliver low voltage for various low power utilities, such as charging mobile phones.

A multi-point power tracking (MPPT) charge controller 9 is arranged to manage the charging of the battery 2. The charge controller 9 is also controlled by the CPU 4. A solar panel, wind turbine or other source 10 of electricity can be connected to the power unit 1 through the charge controller 9.

A mains input illustrated by 11 supplies the battery 2 with electricity through a separate AC/DC charger 12.

The mains electricity can also be directed directly to the switch 7 and further to the outlet 6, to supply electric power without the battery limiting the effect.

Yet another way of charging the battery 2 is through a separate booster 13 coupled to a 12V or 24V electric system on board a vehicle 14 or a ship 15. The booster 13 is voltage sensitive and will start charging the battery 2 only when the generator on board the vehicle 14 or ship 15 is running.

The settings of the various modules in the power unit and the state of the battery can be supervises through a data port 16 to the CPU 4. The communication ca be through Bluetooth®, Wi-Fi or a cable. A state-of-the-art smartphone with appropriate software can be used for this communication.

In order to store enough energy and deliver sufficient power, a battery is built into the power unit. It has been found that a lithium battery is the most viable current battery type, both concerning low weight and small space requirements. As the battery is for a portable power unit, the selected battery is preferably of the type LiFePO4 EV class, i.e. equivalent to the batteries used in electric cars.

Other types of batteries may be relevant for the power unit of the invention, as they are developed, such as solid state batteries or other safe types of batteries that are able to withstand damage from physical influences without catching fire, exploding or being subjected to other incidents.

The total battery size is described here as 58.4 V 40 Ah but can in the power unit of the invention be both larger and smaller depending on the use of the power unit. This applies to both voltage and amperage.

The power unit has a built-in battery management system (BMS), which runs a unique algorithm for charging and discharging that controls each cell of the battery individually to ensure that they all have the same voltage. The algorithm takes into account optimal service life, in relation to currents delivered and the temperature of the battery. If the battery voltage is below a certain threshold or a too high power is attempted drawn from the battery, the BMS may cut the power supply from the battery to protect it.

An active cooling/heating system (not shown in FIG. 1) of the battery built into the cabinet is controlled by the BMS. The active cooling includes a plurality of fans and may also include cooling plates or active liquid cooling. The active battery heating includes an electric heating device.

The BMS also has built-in protection against short circuits in other parts of the system, such as caused by physical influence, e.g. the power unit being subjected to shocks, physical blows or shaking. This is especially important when the power unit is mounted in mobile facilities, such as a van. A short circuit can be detected by an anomalous voltage of the battery, especially a rapid change that cannot be contributed to a supply of electricity. An accelerometer can be built into the power unit, to detect physical shocks above a predetermined limit.

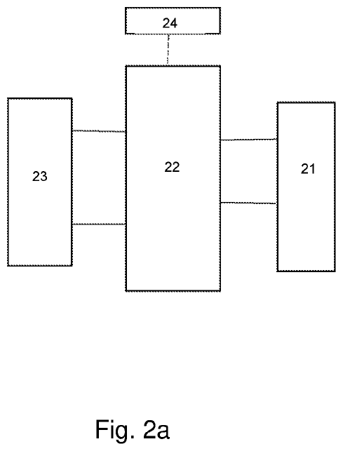

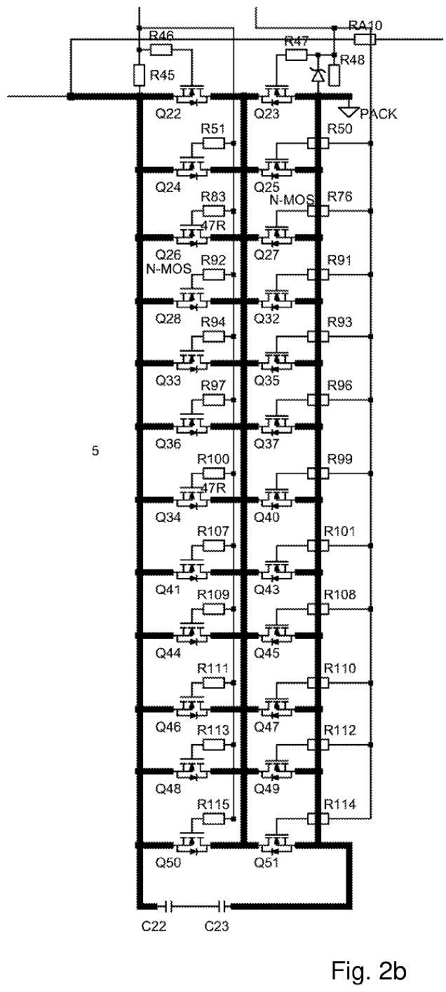

As an alternative illustrated in FIG. 2a the BMS is included in a control unit 22 connected to a power source 21 and battery 23, the control unit 22 being configured to control the battery charging. The control unit 22 is preferably also connected to an external device 24 including a CPU, preferably a wireless connection to a Bluetooth device or similar, for providing external control over the system.

The system may be realized as a modular system with several batteries connected to the same control unit either though conventional connections or specially designed connectors, e.g. making a stack of batteries with common control system or with control units in each battery module being configured to communicate with other with wireless and/or wired connections.

FIG. 2b illustrates the power distribution circuitry in the control unit 22 including a number of low resistance big current MOSFET and extended to MOSFET pack 25 by being connected in parallel, and adapting same port charge/discharge solution.

This way a 12V low voltage LiFePo4 battery can be series/parallel connection and support 3200 W continuously output power with Bluetooth monitor including App with the following features:
The product can support 250 A high current continuously discharge safely and stable 12.8V*250 A=3200 W is the continuously discharge power.
The product can support max. 100V DC charge, that means the modules can be series connection easily. This can support 6 batteries in series at most. For example: single module is 12.8V 200 Ah (2560 Wh), after pack, which can be 12.8V200 Ah*4=51.2V 200 Ah (10240 Wh)

The output current has increased by connecting the MOSFET in parallel, which can support 250 A output at most, and an integrated aluminium plate is used to cool the BMS and reduce the working consumption.

A 100 Ah single cell big prismatic aluminium case is used to build the pack, the configuration is 2P4S. The battery can support 2C continuously output current, that is 400 A in max.

A brass connection plate to make the connection, make sure the stable performance in high discharge current. What's more, we make good protection design of the whole pack and BMS to support the high current output and using integrated aluminium case to support the cooling and safety system.

Furthermore, the BMS can be monitored and controlled via Bluetooth, Wi-Fi or via network cable.

The size of the battery pack can be selected according to the desired use. It is mounted on a strong base plate construction made of materials such as steel, aluminium, carbon fibre or similar. The strong construction of the base plate is due to the mobile application where jerks, vibrations and displacements can occur during driving, sailing or the like. The overall system must be able to withstand such impacts.

This power unit according to the invention will in many cases be placed in a cargo space of a vehicle or ship and may therefore be subject to being hit by objects during transportation.

The power unit has a built-in inverter that preferably is tuned to deliver at least 3000 W continuous power, with the possibility to handle 5000 W in peak for several seconds. However, it is conceivable that the inverter can have both larger and smaller capacity. The inverter is capable of producing an electric current with a pure sine curve. This enables charging of sensitive battery driven appliances, such as PCs or mobile phones.

An important aspect of the power unit is the collaboration between the inverter and the BMS, which ensures that maximum power is delivered to the power consumer while the battery life and performance are optimal. This interface is of utmost importance for the overall system's function and long-term durability.

In general, there will be a great demand for high output power in connection with machines being connected to the AC socket of the power unit. Machines such as angle grinders have a high starting consumption and lower consumption during operation. The power unit should therefore be able to deliver high output for a short time during the starting of such machines.

The task of the inverter is to convert the battery's DC power into usable AC power and create optimal utilization for the user while not causing too large stress on the other parts of the system, such as the battery.

The system conveniently has a built-in multi point power tracking (MPPT) charge controller for solar cells.

An important aspect of the power unit is that it can be connected a solar panel, such as solar cells arranged on the roof of the van. Thereby the battery of the power unit can be charged when the van is parked, ensuring that the battery is kept fully charged when not in use. Alternatively, a small wind turbine can be used. This is especially useful when the power unit is on board a ship.

The MPPT charge controller is therefore built in a configuration that enables it to draw power from a solar panel, such as 3000 Wp solar cells, or a wind turbine, and convert this into a current suitable to charge the battery.

The charge controller runs algorithms that is capable of handling all types of solar cell technology and especially an algorithm suitable for handling power from CIGS technology solar cells. The charging algorithm also being adapted to control the charging of the battery type built into the power unit. The MPPT charge controller is consequently built to work with both the BMS and the inverter due to unique charging algorithms enabling the various parts to play together as one device.

The power unit of the invention has a unique composition that is particularly adapted for transport and portability. In addition to working with the battery management system (BMS), the battery and the inverter, it will have to work with two charging options, AC and DC, from a booster connected to the vehicle's or ship's battery. These functions are built together in the same portable unit.

Another built-in charging option for the power unit is a charger that can convert 110V or 230V AC to DC, e.g. in the de facto standard configuration 58.4 V.

The charger has a built-in bypass function so that the AC current can be conducted directly through the power unit to the AC output. Thus, a power unit according to the invention can also function as an emergency power system. It is even possible to charge the power unit battery at the same time. A switching time of only 2 milliseconds from battery operation to AC operation ensures a seamless operation.

The final charging option is a DC to DC charger, i.e. a so-called booster. In this charging option 12 or 24 volts DC from the vehicle or the ship is converted from the vehicle or ship battery or electric generator to battery voltage in the power unit, e.g. in the de facto standard configuration of 58.4V

It is important that this charging option plays together with the battery management system (BMS), the inverter and the charge controller so that the most environmentally friendly charging option available is automatically selected. The system's software and algorithms are set up for maximum performance from all parts of the system and the maximum lifetime of the overall system

It is preferred that the booster is a separate unit from the power unit, as it is the best option in terms of installation. The booster unit can thus be located between the vehicle's or ship's battery and the power unit and achieve the best possible cooling options. Another reason is cable dimensions, as cables supplying 12 or 24 volt must be thicker than 58.4 volt cables. A placement of the booster unit close to the vehicle's or ship's battery allows for shorter cables.

The booster unit preferably operates with both 12 and 24 V as input.

Another function of the booster is to act as a rail that separates the vehicle's or ship's starter battery from the power unit. This ensures that the battery of the power unit does not drain the vehicle's or ship's starter battery. The booster detects the current on the starter battery and if the voltage rises due to the vehicle or ship having started the engine and the generator is in operation. This function can also be achieved by the booster having a sensor that detects vibration or movement of the vehicle or ship. There can be a built-in delay function which means that the vehicle's or ship's generator will always be able to charge the starter battery first before the booster opens up for charging of the power unit.

This is a usable option on larger mobile installations such as for example workshop vans or trucks and trailers and many other applications where for example more AC outputs are needed. This connection can be done by connecting the DC ports of one or more power units.

Several power units may be connected to utilize one booster but still function as separate solar cell systems and emergency power systems.

1. A portable power unit including a battery management system (BMS) for high current charging of batteries, the system being connected to a power source of a suitable type and a battery pack to be charged, wherein the battery management system includes a charging circuitry including a set of parallel low resistant MOSFET transistors distributing the power to the battery pack.

2. The portable power unit according to claim 1, being provided with means for wireless communication with an external device.

3. The portable power unit according to claim 1, wherein the charging circuitry is positioned in an aluminium case.

4. The portable power unit according to claim 1, wherein the connection to the battery pack is provided through a brass connection plate.

5. The portable power unit according to claim 1, wherein the battery management system is configured to be connected to a number of batteries, providing a modular system.

6. The portable power unit according to claim 1, wherein the battery pack is connected to a battery management system module (BMS) that is controlled by a processor (CPU).

7. The portable power unit according to claim 1, wherein the BMS is coupled to an inverter that in turn is coupled to an electric outlet to deliver AC power to the outlet.

8. The portable power unit according to claim 7, wherein a switch is coupled between said inverter and said outlet.

9. The portable power unit according to claim 6, wherein the CPU is controlling the inverter and the switch.

10. The portable power unit according to claim 1, wherein the unit comprises a multi-point power tracking (MPPT) charge controller capable of converting electric power from various energy sources into a charging current for the battery pack.

11. The portable power unit according to claim 8, wherein a mains electric input can be directed either to the battery pack through a separate AC/DC charger or to the outlet through the switch.

12. The portable power unit according to claim 1, wherein a booster is coupled to a low voltage electric system on board a vehicle or ship, said booster being capable of charging the battery pack.

13. The portable power unit according to claim 6, wherein said CPU is connectable to an external device through Bluetooth®, Wi-Fi or a cable.
